(19) United States
(12) Patent Application Publication
(10) Pub. No.: US 2025/0203053 A1
(43) Pub. Date: Jun. 19, 2025

(54) STEREOSCOPIC IMAGING SYSTEM

(71) Applicant: KARL STORZ Imaging Inc., Goleta, CA (US)

(72) Inventor: Jonathan Bormet, Goleta, CA (US)

(73) Assignee: KARL STORZ Imaging, Inc., Goleta, CA (US)

(21) Appl. No.: 18/636,788

(22) Filed: Apr. 16, 2024

Related U.S. Application Data
(60) Provisional application No. 63/611,936, filed on Dec. 19, 2023.

(51) Int. Cl. H04N 13/128; G06T 5/50; G06T 7/593; G06V 10/25; G06V 10/75; H04N 13/00

(52) U.S. Cl. CPC H04N 13/128; G06T 5/50; G06T 7/593; G06V 10/25; G06V 10/751; G06T 2207/20221; H04N 2013/0081

(57) ABSTRACT

A method for focusing a stereoscopic imaging system includes selecting a Region of Interest (ROI) of a stereo image. The stereoscopic imaging system includes a left-side camera generating a left-side image and a right-side camera generating a right-side image. The method includes adjusting a focus of the left-side camera and the right-side camera and comparing the left-side image and the right-side image within the ROI. The method includes setting the focus of the left-side camera and the right-side camera by processing a one of a disparity, similarity and high frequency content.

### TECHNICAL FIELD

The present disclosure relates generally to the field of stereoscopic imaging systems.

### BACKGROUND

Three dimensional stereoscopic imaging systems traditionally include a pair of cameras that are offset from each other. Images captured by the cameras are processed by a controller and displayed with one image overlaid on the other as a three-dimensional (3D) stereo image. To adjust focus of the stereo images, the user typically manually adjusts focus of the two horizontally offset cameras to adjust the depth of a focal plane relative to the cameras until a desired object or portion of a scene is in focus in the stereo image. However, manual focus of the stereo images can be imprecise and time-consuming. Accordingly, it is desirable to improve the precision and increase efficiency in instances where a conventional three dimensional imaging system is implemented in a surgical procedure.

### SUMMARY

One aspect of the disclosure provides a method for focusing a stereoscopic imaging system having a left-side image sensor and a right-side image sensor. The left-side image sensor and the right-side image sensor generate a corresponding left-side image and right-side image. The left-side image and the right-side image define a stereo image. The method includes providing an optical system including an adjustable focusing optics. The optical system is configured to obtain a best focus focal plane for both the left side image and the right side image that corresponds to a zero, or near zero, disparity between the right side image and the left side image in the stereo image. The method includes selecting a region of interest (ROI). The ROI is a region within one of the left-side image and the right-side image. The method further includes setting a focus of the ROI by adjusting the adjustable focusing optics by processing one of a disparity, similarity, and a high frequency content. The focus of the ROI is set when at least one of the following conditions is satisfied: (1) the disparity between the left side image and the right side image is below the predetermined threshold; (2) the similarity in a pixel intensity between the left side image and the right side image is above a predetermined threshold; and (3) the high frequency content in the left side image and the right side image are above a predetermined threshold.

Implementations of the disclosure may include one or more of the following optional features. In some implementations, the focus of the ROI is set by taking a weighted average of the disparity, similarity and high frequency information.

Optionally, the ROI is determined based on a user input at one of the left-side image and the right-side image.

In some examples, the ROI may be determined based on a user input at the stereo image. In further examples, a graphic overlay representative of the ROI is displayed at both the left-side image and the right-side image based on the user input at the stereo image.

In some implementations, the disparity may be a distance between portions of the left-side image and the right-side image having the same or similar pixel values.

Optionally, the similarity may be determined based on a difference in pixel values for corresponding portions of the left-side image and the right-side image.

In some examples, the similarity may be determined based on at least one of a sum of squared differences and a sum of absolute differences of pixel intensity values of the right image relative to the left image within the ROI.

In some implementations, the similarity may be determined based at least in part on a correlation between the left-side image and the right-side image within the ROI. In further implementations, the correlation is determined based on at least one of a normalized correlation, a cross correlation, a normalized cross correlation, and a zero normalized cross correlation.

Another aspect of the disclosure provides method for focusing a stereoscopic imaging system having a left-side image sensor and a right-side image sensor. The left-side image sensor and the right-side image sensor generate a corresponding left-side image and right-side image defining a stereo image. The method includes providing an optical system including an adjustable focusing optics. The optical system is configured to obtain a best focus focal plane for both the left side image and the right side image that corresponds to a zero, or near zero, disparity between the right side image and the left side image in the stereo image. The method includes selecting a region of interest (ROI). The ROI being a region within one of the left side image and the right side image. The method includes adjusting the adjustable focusing optics to set a focus of the ROI, wherein the focus of the ROI is set when a disparity between the left side image and the right side image within the region of interest is below a predetermined threshold.

In some implementations, when the disparity is below the predetermined threshold, the focus of the left-side camera and the right-side camera is further based on a weighted average of the disparity and a high frequency content in the left-side image and the right-side image within the ROI.

Optionally, the disparity may be determined by a horizontal pixel distance between corresponding regions of the left-side image and the right side image.

In some examples, the disparity may be determined based at least in part on a correlation between the left-side image and the right-side image within the ROI. In such an aspect, the correlation may be determined based on at least one of (i) a normalized correlation, (ii) a cross correlation, (iii) a normalized cross correlation, and (iv) a zero normalized cross correlation.

In yet another aspect of the disclosure provides a stereoscopic imaging system including a left-side camera, a right-side camera, an optical system, an input and a controller. The left-side camera captures left-side images and the right-side camera captures right-side images. The optical system includes an adjustable focusing optics and is configured to obtain a best focus focal plane for both the left side image and the right side image that corresponds to a zero, or near zero, disparity between the right side image and the left side image in the stereo image. The input is configured to select a region of interest (ROI). The ROI is a region within one of the left side image and the right side image and the stereo image. The controller receives the captured left-side images from the left-side camera and the captured right-side images from the right-side camera. The left-side image and the right-side image define a stereo image. The controller includes memory hardware and data processing hardware in communication with the memory hardware. The memory hardware stores instructions that, when executed on the data processing hardware, cause the data processing hardware to perform operations including adjusting a focus of the left-side camera and the right-side camera comparing the left-side image and the right-side image within a Region of Interest (ROI) of the stereo image; and setting the focus of the left-side camera and the right-side camera by processing a disparity, similarity and high frequency content of the left-side image and the right-side image, wherein the focus of the ROI is set when at least one of the following conditions is satisfied: (1) a disparity between the left side image and the right side image is below the predetermined threshold; (2) a similarity in a pixel intensity between the left side image and the right side image is above a predetermined threshold; and (3) a high frequency content in the left side image and the right side image are above a predetermined threshold.

The details of one or more implementations of the disclosure are set forth in the accompanying drawings and the description below. Other aspects, features, and advantages will be apparent from the description and drawings, and from the claims.

### DESCRIPTION OF DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 is a schematic view of a stereoscopic imaging system viewing objects within a scene;

FIG. 2 is a diagram showing the relationship between lens position and focus;

FIG. 3 is a schematic diagram of the stereoscopic imaging system;

FIG. 4 is a left-side image captured by the left-side camera of the stereoscopic imaging system;

FIG. 5 is a right-side image captured by the right-side camera of the stereoscopic imaging system;

FIG. 6 is a stereo image based on the left-side image of FIG. 4 and the right-side image of FIG. 5;

FIGS. 7 and 8 depict a relationship between the determined disparity, similarity and high frequency content between left-side images and right-side images within a region of interest (ROI) as the focal plane of the left-side camera and the right-side camera is adjusted to focus on the ROI; and

FIG. 9 provides a flowchart of an example arrangement of operations for a method of focusing the stereoscopic imaging system.

### DETAILED DESCRIPTION

A method and system for focusing a three-dimensional image is provided, wherein a disparity between the left-camera image and the right-side camera image within a region of interest is determined. The focus of the left-side camera and the right-side camera is automatically adjusted and is set such that the disparity between the left-side image and the right-side image within the ROI is below a predetermined threshold. Accordingly, the method and system improves the precision and efficiency of a three-dimensional stereoscopic imaging system relative to conventional stereoscopic imaging system.

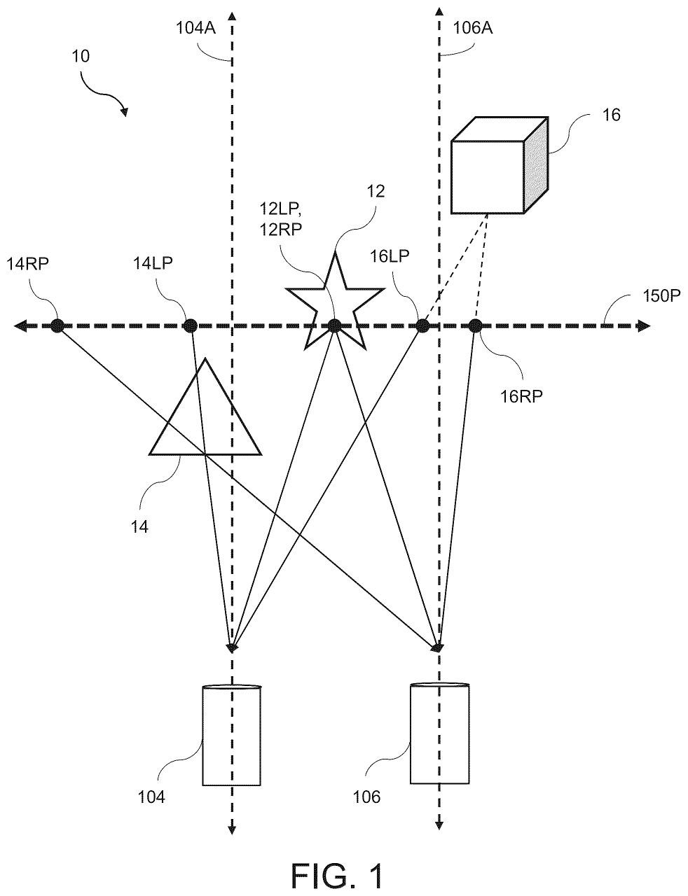

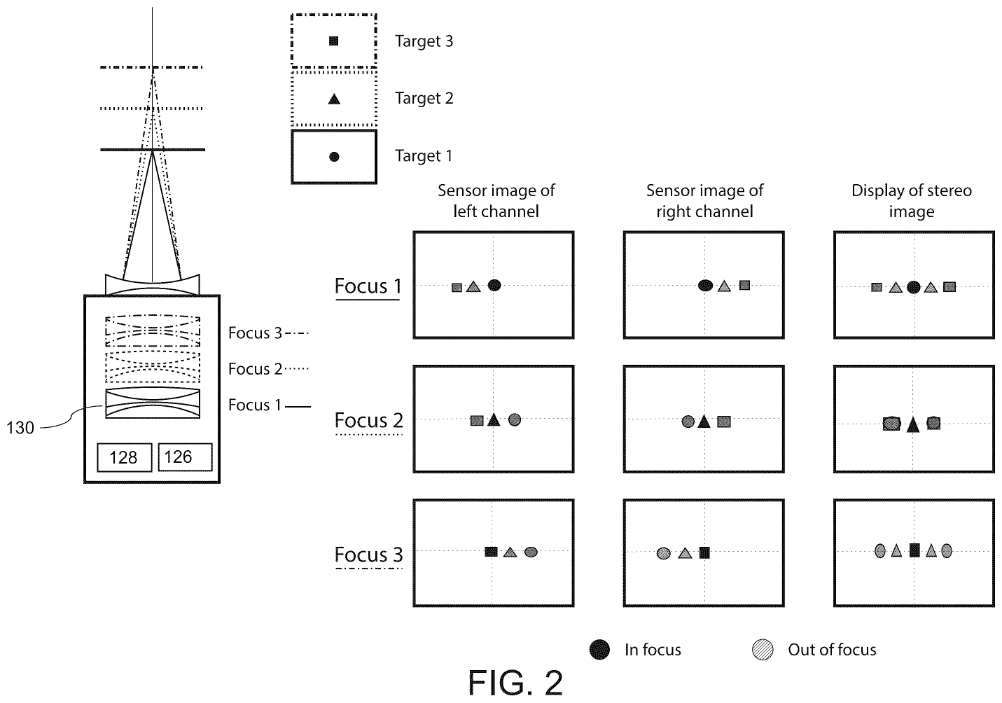

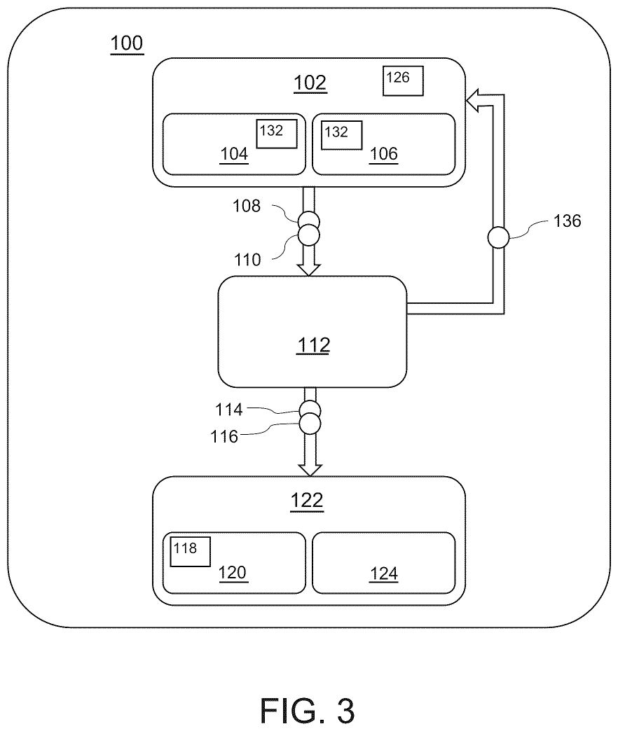

Referring now to the drawings and the illustrated embodiments depicted therein, a stereoscopic imaging system 100 (shown in FIG. 3) includes a left-side camera 104 and a right-side camera 106 that are spaced apart from each other laterally, e.g., along an axis that is generally orthogonal to a center line of a combined field of view. In other words, the cameras 104, 106 are horizontally separated from each other and are both in the same image plane along the optical axis. The left-side camera 104 captures left-side image data 108 and the right-side camera 106 captures right-side image data 110 (FIGS. 1 and 2). The left-side camera 104 and the right-side camera 106 may be accommodated in a stereoscopic imaging instrument 102. It should be noted that while the stereoscopic imaging instrument 102 may take the form of any number of potential scopes, such as an exoscope, endoscope, borescope, etc., the present disclosure will be primarily drawn to, and use as a primary example, an exoscope 102 for use in surgical procedures, although this example is non-limiting. In such an aspect, the lateral distance between the left-side camera 104 and the right-side camera 106 may be fixed. However, it should be appreciated that the lateral distance may be adjusted by known adjustment mechanisms or manually by a track system. For illustrative purposes, a description of the stereoscopic imaging instrument 102 is made in the context of the left-side camera 104 and right-side camera 106 being fixed. The left-side image data 108 and the right-side image data 110 may be processed at camera control unit (CCU) 112 of the system 100 to generate the left-side images frames 114, the right-side image frames 116, and/or a stereo image 118 is displayed for viewing by a user at a display screen 120.

The left-side image data 108 and the right-side image data 110 may be displayed separate from one another at respective left-side and right-side ocular assemblies configured for independent viewing by respective left and right eyes of a user to provide the stereo image 118 (e.g., viewing the stereo image via display goggles). Alternatively, the left-side image frame 114 and the right-side image frame 116 may be at least partially overlapped to generate the stereo image 118 for display at the display screen 120 (e.g., viewing the stereo image via a display monitor) as is known in the art of 3D display. The CCU 112 may include any suitable electronic circuitry (e.g., memory hardware and data processing hardware) and associated software configured to control operation of the stereoscopic imaging system 100 and provide display of the stereo images 118 for viewing by the user. As discussed further below, the display screen 120 may be part of a user interface 122 of the stereoscopic imaging system 100, which includes a user actuatable input 124, such as a touch screen, mouse, keyboard or the like, for receiving a user input from the user to adjust display of the stereo image 118 and select an ROI 200.

The left-side camera 104 and the right-side camera 106 are laterally offset from one another at the exoscope 102 and have respective principle viewing axes 104A, 106A (as shown in FIG. 1) that are parallel to one another. Further, the left-side camera 104 and the right-side camera 106 have respective focuses or focal planes (150) that are set equal to one another and that are adjustable together and in tandem with one another. For example, when the focus of the left-side camera 104 and the right-side camera 106 adjusted such using an adjustment mechanism such as a motor 126. The motor 126 may adjust the focus of the left-side camera 104 and the right-side camera 106 by manipulating one or more of the following: the position of a left image sensor 128 and a right image sensor 130 positions of the left-side and right-side cameras 104, 106 as shown in FIG. 2, or adjusting the adjustable focusing optics 132 (see FIG. 2), and manipulating the shape of respective deformable lenses of the left-side camera 104 and the right-side camera 106, and the like. For use herein, a system 100 is described wherein the motor 126 may advance or retract the adjustable focusing optics 132 which provides image data 108, 110 to the left and right image sensors 128, 130 in a synchronized manner wherein the focal length of the left-side camera 104 and the right-side camera 106 are equal to each other.

With reference now to FIG. 1, the focus of the left-side camera 104 and the right-side camera 106 are substantially equal to one another and the left-side camera 104 and the right-side camera 106 are mechanically adjusted together, the stereo image 118 is in focus at a distance or depth from the left-side camera 104 and the right-side camera 106 along a focal plane 150P that is perpendicular to the principle viewing axis 104A of the left-side camera and the principle viewing axis 106A of the right-side camera 106. That is, portions of the 3D stereo image 118 appear in focus to a user viewing the display screen 120 at a depth within the 3D stereo image 118 that corresponds to the depth of the focal plane 150P from the left-side camera 104 and the right-side camera 106. Thus, when the stereoscopic imaging system 100 is viewing a scene 10, such as a surgical scene, objects or surfaces located within the scene 10 will appear in focus within the stereo image 118 when the focal plane 150P is at a depth or distance that aligns with the object or surface within the scene 10. Objects located at depths or distances different from the focal plane 150P may appear out of focus and/or in the foreground or background of the 3D stereo image 118 at the display screen 120.

Referring again to FIG. 1, because the left-side camera 104 and the right-side camera 106 are laterally offset from one another, pixel positions in the left-side image frames 114 and the right-side image frames 116 corresponding to the respective objects within the scene 10 may be laterally offset as well. In other words, there may be a horizontal separation between the appearance of an object in the left-side images 114 and the right-side image frames 116. Thus, there may be a stereoscopic disparity between corresponding points or portions of the left-side image data 108 and the right-side image data 110. As used herein, the term “disparity” means a horizontal distance (measured in units of pixels) between corresponding views of an object in the left-side image data 108 and the right-side image data 110, and correspondence can be determined by examining differences in data values such as intensity, color, and the like. Put another way, pixels of the left image sensor 128 and the right image sensor 130 (e.g., individual pixels or groups of pixels) having same or similar values (e.g., intensity) in the left-side image data 108 and the right-side image data 110 (and thus representing the same object in the scene) may be located at respective pixel positions in the left-side image frame 114 and the right-side image frame 116 that are spaced apart from one another. For example, disparity may be measured in units of pixels between corresponding portions of the left-side image frame 114 and the right-side image frame 116, e.g. the spatial displacement of corresponding portions of the left-side image frame 114 and the right-side image frame 116 and the spatial displacement may be processed to determine the depth of the object relative to the focal plane 150P. Thus, in accordance with the present invention, when a given object within the scene 10 is in focus in the stereo image 118 (i.e., the object is aligned with the focal plane 150P), the disparity is at or near zero and pixels at the same coordinates of the left-side image frame 114 and the right-side image frame 116 have same or similar values, such that correlation between pixels in the left-side image frame 114 and the right-side image frame 116 is maximized.

Referring again to FIG. 1, the focus of the left-side camera 104 and the right-side camera 106 is adjusted so that the focal plane 150P aligns with a first object 12 within the scene 10 and the first object 12 is in focus within the 3D stereo image 118, in other words, the first object 12 is placed into focus because at the focal plane 150P for both the left-side image frame 114 and the right-side image frame 116 corresponds to a zero, or near zero, disparity between the right-side image frame 116 and the left-side image frame 114 in the stereo image 118. That is, the first object 12 is positioned within the scene 10 at a distance or depth from the left-side camera 104 and the right-side camera 106 that corresponds to the distance or depth of the focal plane 150P from the left-side camera 104 and the right-side camera 106. Thus, a left-side image pixel position 12LP of the first object 12 (i.e., the position of one or more pixels within the left-side image frame 114 that correspond to the first object 12) and a right-side image pixel position 12RP of the first object 12 (i.e., the position of one or more pixels within the right-side image frame 116 that correspond to the first object 12) coincide in the stereo image 118 and the first object 12 is in focus at the display screen 120.

A second object 14 is positioned within the scene 10 closer to the left-side camera 104 and the right-side camera 106 than the first object 12 and thus is in the foreground of the stereo image 118 with respect to the focal plane 150P. As shown, a left-side image pixel position 14LP of the second object 14 and a right-side image pixel position 14RP of the second object 14 are laterally offset from one another in the stereo image 118 (as represented by the intersections of the left-side image pixel position 14LP and the right-side image pixel position 14RP with the focal plane 150P) and thus the second object 14 may be out of focus at the display screen 120. The disparity is measured to be the distance defined by the lateral offset between the position of one or more pixels within the left-side image frame 114 that correspond to the second object 14 and the corresponding one or more pixels within the right-side image frame 116 that correspond to the second object 14.

A third object 16 is positioned within the scene 10 farther from the left-side camera 104 and the right-side camera 106 than the first object 12 and thus is in the background of the stereo image 118 with respect to the focal plane 150P. A left-side image pixel position 16LP of the third object 16 and a right-side image pixel position 16RP of the third object 16 are laterally offset from one another in the stereo image 118 (as represented by the intersections of the left-side image pixel position 16LP and the right-side image pixel position 16RP with the focal plane 150P) and thus the third object 16 may be out of focus at the display screen 120. The disparity is measured to be the distance defined by the lateral offset between the position of one or more pixels within the left-side image frame 114 that correspond to the third object 16 and the corresponding one or more pixels within the right-side image frame 116 that correspond to the third object 16. It should be noted that the sign of the disparity value of a given object closer to the cameras 104, 106 than the focal plane 150P will be the opposite of the sign of the disparity value of an object farther from the cameras 104, 106 than the focal plane 150P.

Because the relative depth of the objects and surfaces within the scene 10 relative to the focal plane 150P of the 3D stereo image 118 (i.e., the depth within the scene at which objects appear in focus in the stereo image 118) is related to the disparity between the left-side image data 108 and the right-side image data 110, the stereo image 118 can be focused on an object or surface or region of interest (ROI 200) in the stereo image 118 by automatically adjusting focus of the left-side camera 104 and the right-side camera 106 in unison with each other until the disparity between the left-side image frame 114 and the right-side image frame 116 at the ROI 200 is minimized (e.g., the disparity is at or near zero, or below a predetermined threshold). For example, the second object 14 in FIG. 1 can be brought into focus in the stereo image 118 by adjusting the adjustable focusing optics 132 or the position of the image sensors 128, 130 and thus by adjusting the focal plane 150P, such that the left-side image pixel position 14LP of the second object 14 and the right-side image pixel position 14RP of the second object 14 are aligned (i.e., there is zero (or minimized) disparity between the left-side image pixel position 14LP and the right-side image pixel position 14RP). The focal plane 150P of the stereo image 118 is at or near the depth of an object within the ROI 200 when pixel locations in the left-side image frame 114 and the right-side image frame 116 that correspond to the objects represented in the ROI 200 have the same or similar values. Thus, a ROI 200 can be brought into focus in the 3D stereo image 118 by the process of adjusting the cameras 104, 106 through a range of focuses and comparing the pixel values of the left-side image data 108 and the right-side image data 110 that correspond to the ROI 200 in the left-side images 114 and the right-side image frames 116 at the different focuses of the left-side camera 104 and the right-side camera 106, and selecting the focus value (i.e., the depth of the focal plane 150P) at which the disparity between the pixels of the left-side image frame 114 and the right-side image frame 116 corresponding to the ROI 200 is at or near zero, e.g. the pixel values are the same or similar.

With reference now to FIG. 2, the stereoscopic imaging system 100 includes a left-side camera 104 and a right-side camera 106 each having a left image sensor 128 and a right image sensor 130 and adjustable focusing optics 132 which are moveable relative to the left image sensor 128 and right image sensor 130. For illustrative purposes, the focusing optics 132 is shown as a generic lens group and it should be appreciated that any lens or lens group currently known or later adopted may be modified for use herein. The adjustable focusing optics 132 is movable between Focus 1, Focus 2 and Focus 3. FIG. 2 illustrates the position of Targets 1, 2, and 3 at different focal planes by a respective left-side camera 104 and right-side camera 106 and the corresponding stereoscopic image. That is, target 1 is closest to the exoscope 102 and target 3 is furthest from the exoscope 102 and target 2 is disposed between targets 1 and 3. At Focus 1, the Target 1 is placed in focus by both the left-side camera 104 and the right-side camera 106. When generating a stereoscopic image, the images taken by the left-side camera 104 and the right-side camera 106 are overlaid onto each other which makes targets 2 and 3 appear on both sides of target 1. At Focus 2, the Target 2 is placed in focus by both the left-side camera 104 and the right-side camera 106 and when generating a stereoscopic image, the images taken by the left-side camera 104 and the right-side camera 106 are overlaid onto each other which makes the images of targets 1 and 3 superimposed onto each other and appear on both sides of target 2. At Focus 3, the Target 3 is placed in focus by both the left-side camera 104 and the right-side camera 106. When generating a stereoscopic image, the images taken by the left-side camera 104 and the right-side camera 106 are overlaid onto each other which makes targets 2 and 3 appear on both sides of target 1. FIG. 2 is helpful in understanding that the left-side and right-side cameras 104, 106 provide a left and right perspective of a target.

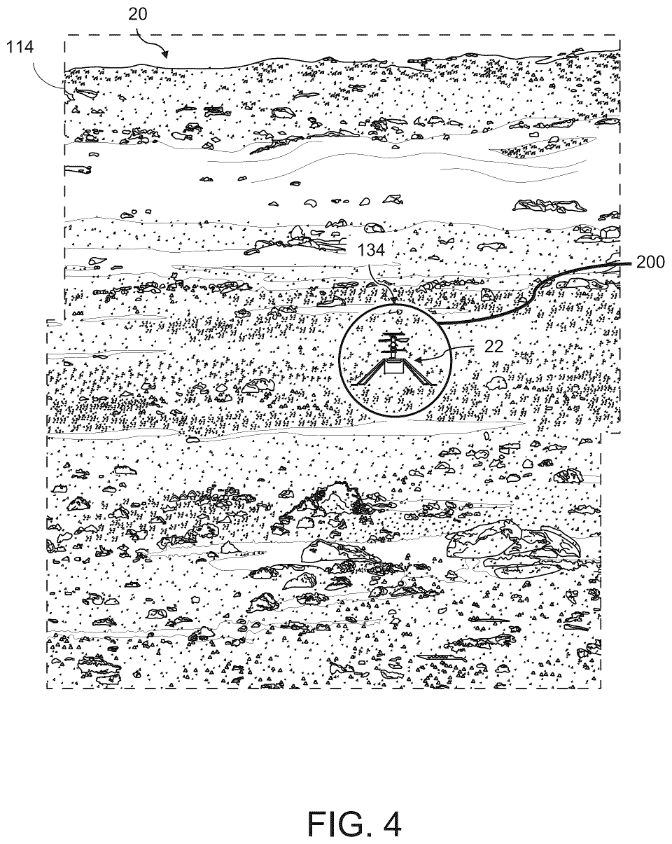

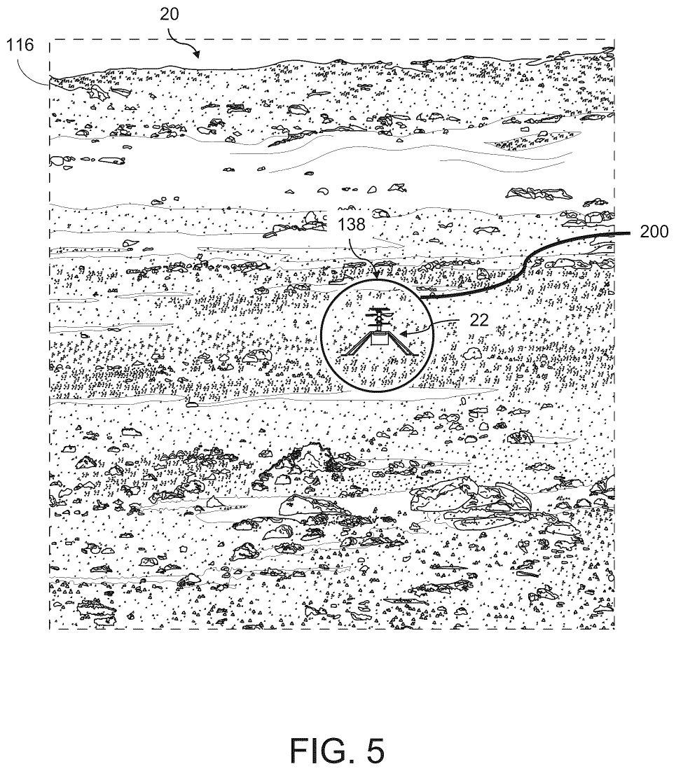

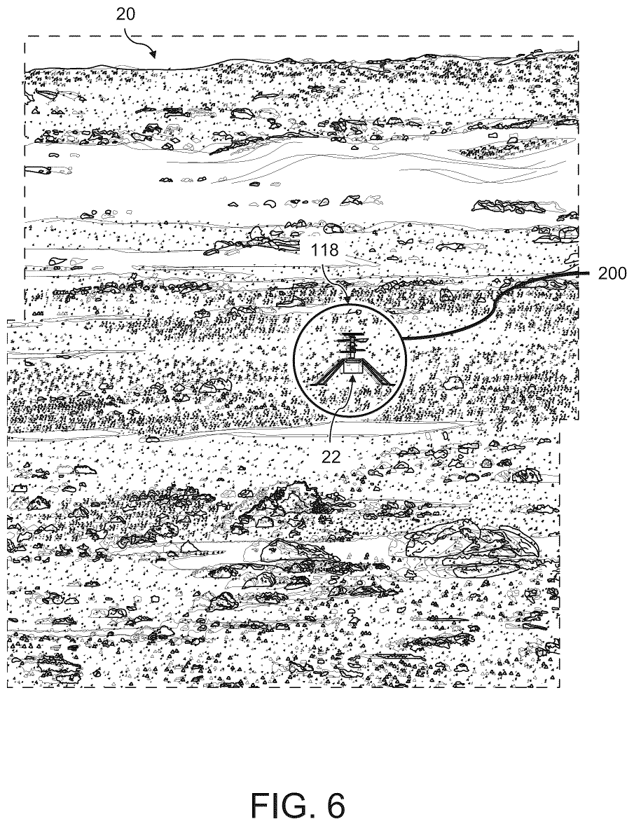

In order to provide conceptual examples of the present 3D imaging process, reference is made to FIGS. 4-6, wherein representations of 3D image data acquired by NASA's Perseverance rover featuring a Martian landscape and the Ingenuity rotorcraft are presented. These images are used purely as generic, publicly available 3D examples for the sole purpose of explaining the present systems and methods. FIG. 4 depicts an example left-side image frame 114, FIG. 5 depicts an example right-side image frame 116, and FIG. 6 depicts an example 3D stereo image 118 formed by at least partially overlaying the example left-side image frame 114 and the example right-side image frame 116. Referring to FIGS. 2-6, when viewing the 3D stereo image 118 at the display screen 120, the user provides an input at the user actuatable input 124 to select an ROI 200 of the stereo image 118. For example, the CCU 112 may be configured to, upon the selection of an ROI 200, generate an autofocus command to bring the stereo image 118 into focus at the selected ROI 200 (i.e., a portion of the stereo image 118 corresponding to an object or surface within the scene). In the illustrated example of FIGS. 3-5, the ROI 200 corresponds to the object 22 (e.g., the Ingenuity rotorcraft) within the scene 20 (e.g., the Martian landscape).

Based on the actuation of the user actuable input 124, the system 100 (such as via processing at the CCU 112) may determine the respective portions of the left-side image frame 114 and the right-side image frame 116 that correspond to the selected ROI 200. In one aspect, upon actuation of the user actuable input 124, the system presents on of the left-side image frame and the right-side image frame 116 on the display screen 120 and the user selects an ROI 200 using the presented left-side image frame and the right-side image frame 116. In another aspect, the system 100 is configured to process the actuation of the user actuable input 124 to select the ROI 200. In other words, the system 100 selects one of a left-side portion 134 of the left-side image frame 114 within the ROI 200 (e.g., one or more pixels or a group of pixels within the left-side image frame 114) or a right-side portion 138 of the right-side image frame 116 within the ROI 200 (e.g., one or more pixels or a group of pixels within the right-side image frame 116) based upon the input received from the user actuable input 124. The left-side portion 134 and the right-side portion 138 correspond to one or more pixels at the same coordinates or region of the respective left image sensor 128 and the right image sensor 130 but have non-identical pixel values particularly when there is a disparity between the left-side image frame 114 and the right-side image frame 116 at the ROI 200. That is, if the object 22 is at a different depth within the scene 20 than the current focal plane 150P, the object 22 appears in offset pixel locations in the left-side image frame 114 and the right-side image frame 116 and there is a disparity between the left-side image frame 114 and right-side image frame 116 within the ROI 200. Thus, the pixel values of the left-side portion 134 will be at least partially different from the pixel values of the right-side portion 138 within the ROI 200.

In some examples, the ROI 200 is automatically identified as the central region or portion of the stereo image 118 upon actuation of input 124 in which case the CCU 112 generates an autofocus command. Thus, the system 100 determines the left-side portion 134 and the right-side portion 138 corresponding to the ROI 200 in the respective left-side image frame 114 and the right-side image frame 116 based on the central portion of the stereo image 118 at the display screen 120. In such a case, the user may simply position the imaging instrument 102 to obtain a desired ROI 200.

In some examples, the system 100 is configured to allow the user to make a selection of the ROI 200 at the display screen 120 via the user actuatable input 124, such as via a mouse, touchpad, trackball, touchscreen, and the like. For example, when the user selects the ROI 200 (e.g., an object within the stereo image 118), the user views one of the left-side image frame 114 and the right-side image frame 116 (i.e., a two dimensional (2D) image) and the user selects the ROI 200 at the 2D image. That is, the display screen 120 displays the 2D image at the time the user makes the ROI 200 selection (e.g., the 2D display may be triggered by the user, such as via a foot pedal prior to selection, causing one of the overlaid left-side image frame 114 or right side image frame 116 to be temporarily removed until such a selection is made) and the user selects the object to be focused on within the 2D image. Thus, the user selection may define the ROI 200 from one of the left-side portion 134 and the right-side portion 138, and based on this selection, on a 2D image, the other of the left-side portion 134 and the right-side portion 138 is determined.

Optionally, when the user selects the ROI 200, the user views the 3D stereo image 118 and selects the ROI 200 at the 3D stereo image 118. To improve the user's ability to discriminate which object within the scene is to be selected within the 3D stereo image 118, a graphic overlay 170 is provided at the display screen 120 that is representative of the user selection. For example, when the display screen 120 is provided at separate left and right display elements (e.g., stereoscopic goggles or glasses), the graphic overlay 170 is displayed at one of the left-side image frame 114 and the right-side image frame 116 to represent the selected object within the left-side image frame 114 or the right-side image frame 116. The graphic overlay 170 may include any suitable representation, such as a semi-transparent square block representative of the pixel selection in the left-side image frame 114 or the right-side image frame 116. For illustrative purposes, the graphic overlay 170 is shown as a circle in FIGS. 4-6.

In response to receiving the autofocus command, the CCU 112 actuates the motor 126 to adjust adjustable focusing optics 132 to change the focus of the left-side camera 104 and the right-side camera 106, adjusting the disparity between the left-side portion 134 and the right-side portion 138. For example, the CCU 112 processes the image data 136 to generate instructions for adjusting focus of the left-side camera 104 and the right-side camera 106. As the focus of the left-side camera 104 and the right-side camera 106 is adjusted and the focal plane 150P approaches the object 22 of the ROI 200, the disparity between the left-side image frame 114 within the ROI 200 and the right-side image frame 116 within the ROI 200 decreases and thus the similarity or correlation in pixel values of the left-side portion 134 and the right-side portion 138 increases.

For example, and as shown in FIGS. 4-6, the focal plane 150P (not shown) is set to a depth that is near the distance of the object 22 within the scene 20 from the left-side camera 104 and the right-side camera 106. The focal plane 150P is not exactly aligned with the object 22 as there is a slight disparity between the left-side image frame 114 within the ROI 200 and the right-side image frame 116 within the ROI 200. However, the focal plane 150P is closer to the object 22 than the focal plane 150P is to other surfaces within the scene 20, as shown by the greater disparity between corresponding portions of the scene 20 in the foreground and background as compared to the disparity at the ROI 200. Thus, while the pixel values at the left-side portion 134 and the right-side portion 138 are not identical (primarily as a result of the perspective seen by each of cameras 104, 106), the small or minor disparity at the ROI 200 indicates that the pixel values are highly similar and thus the object 22 is determined to be in focus in the stereo image 118.

Thus, in order to properly provide focus to the selected ROI 200, once the ROI 200 is selected, the system 100 adjusts the focusing optics 132 of the left-side camera 104 and the right-side camera 106 (e.g., via commands) and captures left-side image data 108 and right-side image data 110 at a plurality of focuses (i.e., depths of the focal plane 150P from the left-side camera 104 and the right-side camera 106). The system 100 processes the left-side image data 108 and the right-side image data 110 and sets the focus of the selected ROI 200 by adjusting the adjustable focusing optics processing a disparity, a similarity and/or a high frequency content between the left-side portion 134 and the right-side portion 138 based on the processed image data 136. Subsequent to analyzing the comparison information (e.g. the disparity, similarity and/or high frequency content) received corresponding to the region within the selected ROI 200, the system 100 sets the focus of the left-side camera 104 and the right-side camera 106 when one of the following conditions is satisfied: (1) the disparity between the left side image and the right side image is below the predetermined threshold; (2) the similarity in a pixel intensity between the left side image and the right side image is above a predetermined threshold; and (3) the high frequency content in the left side image and the right side image are above a predetermined threshold. For example, the CCU 112 may actuate the motor 126 to adjust the adjustable focusing optics and modify the focal length of the left-side camera 104 and the right-side camera 106 by a predetermined distance, e.g., moves the focusing optics for the left-side camera 104 and the right-side camera 106, and the CCU 112 processes the left-side image data 108 and right-side image data 110, compares the left-side image frame 114 and right-side image frame 116 and set the focus based on the processed image data 136.

As stated above, the focus of the selected ROI 200 is determined by processing at least one of disparity, similarity and high-frequency content between left-side image frames 114 and right-side image frames 116. In one example, the processed image The CCU 112 continues to perform this process until the disparity is at or near zero. In one example, the imaging optics of left-side camera 104 and the right-side camera 106 are advanced four times in a predetermined increment so as to move closer towards the object, and the system 100 performs four analyses of the left-side image data 108 and right-side image data 110 at each increment. In such an example, a disparity between the left-side image data 108 and right-side image data 110 is determined at each increment. It may be that the disparity between the left-side image data 108 and right-side image data 110 decreases from the first to the third increment and then increases at the fourth increment, in which case the focus at the third increment is used as the focus value deemed to provide the best correlation.

In some examples, the disparity between the left-side image frame 114 and the right-side image data 110 within the ROI 200 is determined based on a similarity or correlation between the left-side portion 134 and the right-side portion 138. That is, the disparity between the left-side image frame 114 and the right-side image frame 116 within the ROI 200 is determined based on a comparison of the pixel values of the left-side portion 134 and the right-side portion 138. The greater the similarity between the left-side portion 134 and the right-side portion 138, the smaller the disparity. Thus, a correlation or similarity score may be determined for each of the one or more respective focuses of the left-side camera 104 and the right-side camera 106 to determine the disparity at the respective focuses.

For example, the disparity is determined based on a normalized correlation of the left-side image data 108 and the right-side image data 110 corresponding to the ROI 200, where the normalized correlation is given by the equation:

$$\frac{\sum \sum L ( r , c ) \times R ( r , c - d )}{\sqrt{( \sum \sum {L ( r , c )}^{2} ) \times ( \sum \sum {R ( r , c - d )}^{2} )}} .$$

The normalized correlation is maximized (e.g., approaches one) as the disparity (d) decreases and the similarity between the respective pixel values at row (r) and column (c) coordinates of the left-side image frame 114 (L) within the ROI 200 and the right-side image frame 116 (R) within the ROI 200 increase.

Optionally, the similarity is determined based on a cross correlation of the left-side image data 108 and the right-side image data 110 corresponding to the ROI 200, where the mean of each ROI 200 is subtracted to determine the similarity between the left-side image frame 114 and the right-side image frame 116 within the ROI 200. Optionally, the similarity is determined based on a normalized cross correlation of the left-side image data 108 and the right-side image data 110 corresponding to the ROI 200, where the data is divided by the standard deviation of each ROI 200 to determine the similarity between the left-side image frame 114 and the right-side image frame 116 within the ROI 200. Optionally, the disparity is determined based on a zero normalized cross correlation of the left-side image data 108 and the right-side image data 110 corresponding to the ROI 200, where the data is divided by the standard deviation of each ROI 200 and the mean of each ROI 200 is subtracted to determine the similarity between the left-side image frame 114 and the right-side image frame 116 within the ROI 200. Optionally, the disparity is determined based on a phase correlation of the left-side image data 108 and the right-side image data 110 corresponding to the ROI 200, where the data is evaluated as a cross-power spectrum in the Fourier domain, with the magnitude of the Fourier coefficients normalized, to determine the similarity between the left-side image frame 114 and the right-side image frame 116 within the ROI 200.

In some examples, the disparity between the left-side image frame 114 and the right-side image data 110 within the ROI 200 is determined based on a dissimilarity or difference in pixel values between the left-side portion 134 and the right-side portion 138. The smaller the difference between the left-side portion 134 and the right-side portion 138, the smaller the disparity. Thus, the difference in pixel values within the ROI 200 may be determined for each of the one or more respective focuses of the left-side camera 104 and the right-side camera 106 to determine the disparity at the respective focuses.

For example, the similarity may be based upon the differences of pixel intensity values of the right image relative to the left image within the ROI. For instance, the similarity may be determined based on a sum of squared differences (SSD) of the left-side image data 108 and the right-side image data 110 corresponding to the ROI 200, where the disparity is given by

$$SSD = \sum \sum {( L ( r , c ) - R ( r , c - d ) )}^{2} .$$

The sum of squared differences is minimized (e.g., approaches zero) as the disparity (d) decreases and the difference between the respective pixel values at row (r) and column (c) coordinates of the left-side image frame 114 (L) within the ROI 200 and the right-side image frame 116 (R) within the ROI 200 decreases.

Similarly, the similarity may be determined based on a sum of absolute differences of the left-side image data 108 and the right-side image data 110 corresponding to the ROI 200, where the disparity is given by

ΣΣ|(L(r,c)−R(r,c−d))|.

As the system 100 automatically adjusts the focus of the left-side camera 104 and the right-side camera 106 and determines the disparity within the ROI 200 at the respective focuses, the system 100 sets the focus of the left-side camera 104 and the right-side camera 106 when the disparity between the left-side image frame 114 and the right-side image frame 116 within the ROI 200 is within an acceptable range. For example, the CCU 112 transmits the command to the left-side camera 104 and the right-side camera 106 to set the focus when the disparity is below a predetermined threshold. For example, the disparity is below the predetermined threshold when the determined correlation is above a predetermined threshold (e.g., 0.75, 0.80, 0.90, 0.95, 0.99, and the like).

Optionally, as the system 100 adjusts the focus of the left-side camera 104 and the right-side camera 106 to the one or more focuses, the system 100 selects the focus out of the one or more focuses where the similarity and high-frequency content are maximized. In other words, the system 100 sets the focus to be the focus of the one or more focuses where the commonality between the left-side portion 134 and the right-side portion 138 is the greatest. For example, the CCU 112 performs a comparison of pixel intensity values of corresponding pixels of left and right image frames 114, 116 and sets the focus when the pixel intensities are the most common. A similar process may be performed using high-frequency content.

Optionally, the system 100 continues to adjust the focus of the left-side camera 104 and the right-side camera 106 to additional focuses (e.g., to continue to move the focal plane 150P toward or away from the exoscope 102) while the disparity decreases and sets the focus when the disparity begins to increase. Because the disparity decreases as the focal plane 150P approaches the object of the ROI 200 and the disparity increases as the focal plane 150P moves away from the object of the ROI 200, the focal plane 150P can be positioned at or near the object of the ROI 200 by this method.

Focus of the left-side camera 104 and the right-side camera 106 can be further refined using curve-fitting (e.g., a Gaussian or normal distribution) and interpolation of the disparity metric. Thus, the disparity between the left-side image frame 114 and the right-side image frame 116 within the ROI 200 may be further reduced from the selected focus of the one or more focuses (e.g., where disparity is below the predetermined threshold).

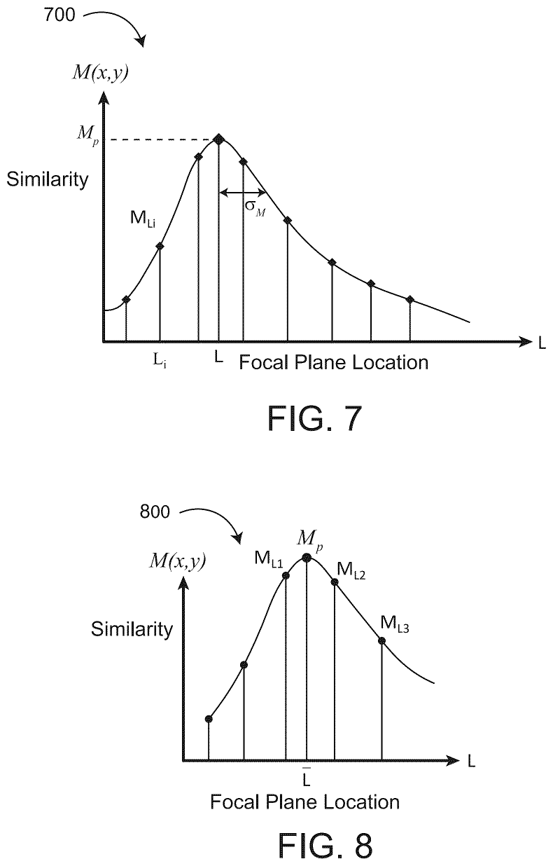

For example, and such as shown in the graph 700 of FIG. 7, as the focus of the left-side camera 104 and the right-side camera 106 is adjusted (as represented by the Focal Plane Locations L along the x axis of the graph 700), the determined correlation between the left-side image frame 114 and the right-side image frame 116 within the ROI 200 increases and decreases (as represented by the Focus Measures M along the y axis of the graph 600). For example, the Focus Measure M may represent the correlation between pixel values of the left-side image frame 114 and the right-side image frame 116 within the ROI 200. Thus, as the Focus Measure M increases, the disparity within the ROI 200 decreases.

In the illustrated example of FIG. 7, an initial Focus Measure Mᵢ is determined at an initial Focal Plane Location, which is generated by the position of the focusing optics 132, such as at the focus of the left-side camera 104 and the right-side camera 106 when the user provides the autofocus command 160a. The system 100 adjusts the focus of the left-side camera 104 and the right-side camera 106, in this example by moving the position of the lens of the focusing optics 132, incrementally to determine the curve Ms based on the respective Focus Measures M at the stepped Lens location. The disparity within the ROI 200 is at a minimum when the Focus Measure M is at a maximum Focus Measure Mₚ and the focus of the left-side camera 104 and the right-side camera 106 is adjusted to Lens Location “L̅”. However, the maximum Focus Measure Mₚ and corresponding Lens Location “L̅” are unknown when the Lens Location “Lᵢ” does not correspond to one of the stepped Lens Locations “Lᵢ”. The Focus Measure curve Mₛ may be represented by:

$${M}_{s} = {M}_{p} exp \{ - \frac{1}{2} {( \frac{s - \overline{s}}{{σ}_{M}} )}^{2} \} ,$$

where “s” and “S̅” are the lens location.

By solving for the maximum Focus Measure Mₚ, the corresponding Lens Location S̅, and the difference in Focus Measure δ_{M} between the maximum Focus Measure Mₚ and the next stepped Lens Location S using Focus Measures Mₛ₁, Mₛ₂, Mₛ₃ at three corresponding Lens Locations S₁, S₂, S₃ (e.g., the graph 700 in FIG. 8), the Lens Location S (i.e., the focus of the left-side camera 104 and the right-side camera 106) that provides the maximum Focus Measure Mₚ may be determined by:

$$\overline{L} = \frac{( ln {M}_{L 2} - ln {M}_{L 3} ) ( {L}_{2}^{2} - {L}_{1}^{2} )}{2 ( {L}_{3} - {L}_{2} ) \{ ( ln {M}_{L 2} - ln {M}_{L 1} ) + ( ln {M}_{L 2} - ln {M}_{L 3} ) \}} - \frac{( ln {M}_{L 2} - ln {M}_{L 1} ) ( {L}_{2}^{2} - {L}_{3}^{2} )}{2 ( {L}_{3} - {L}_{2} ) \{ ( ln {M}_{L 2} - ln {M}_{L 1} ) + ( ln {M}_{L 2} - ln {M}_{L 3} ) \}} .$$

Thus, the focus of the left-side camera 104 and the right-side camera 106 at which the focal plane 150P is at or near the object of the ROI 200 within the scene may be determined computationally, such as at the CCU 112, and the CCU 112 may provide a command to adjust the focus of the left-side camera 104 and the right-side camera 106 to the selected focus. In other words, the system 100 may determine the focus of the left-side camera 104 and the right-side camera 106 at which the focal plane 150P is at or near the object of the ROI 200 without first adjusting the focus to the optimized focus and determining the disparity at the optimized focus. The optimized focus may be determined based on the calculated disparity at other focuses.

Furthermore, when the stereo image 118 is at or near focus at the ROI 200, the left-side image frame 114 and the right-side image frame 116 may have a high measure of high frequency content within the ROI 200. Thus, setting the focus of the left-side camera 104 and the right-side camera 106 may be based at least in part on high frequency content in the left-side image frame 114 and the right-side image frame 116 within the ROI 200. For example, setting the focus is based on a weighted average of the high frequency content in the left-side image frame 114 and the right-side image frame 116 within the ROI 200 and the determined disparity between the left-side image frame 114 and the right-side image frame 116 within the ROI 200.

In some examples, while adjusting the focus of the left-side camera 104 and the right-side camera 106 to one or more focuses and for each respective focus, the system 100 determines a stereoscopic similarity score (e.g., based on a correlation between the left-side image data 108 and the right-side image data 110 within the ROI 200), a left-side image high frequency content score (e.g., based on a measure of high frequency content in the left-side image frame 114), and right-side image high frequency content score (e.g., based on a measure of high frequency content in the right-side image frame 116). The selected focus of the left-side camera 104 and the right-side camera 106 can be determined by finding the peak of any one of the three values as the focuses are adjusted. Optionally, the selected focus is determined by weighting each metric. It should be appreciated that the graphs depicted in FIGS. 7 and 8 are provided for illustrative purposes, and though these graphs show an aspect where the focus of the ROI 200 is set using similarity, the same principles may be applied when using disparity and high-frequency content. For example, the focus may be set when a graph plotting disparity or high frequency reaches a trough, or in a step between when the measured disparity decrease and then increases in value.

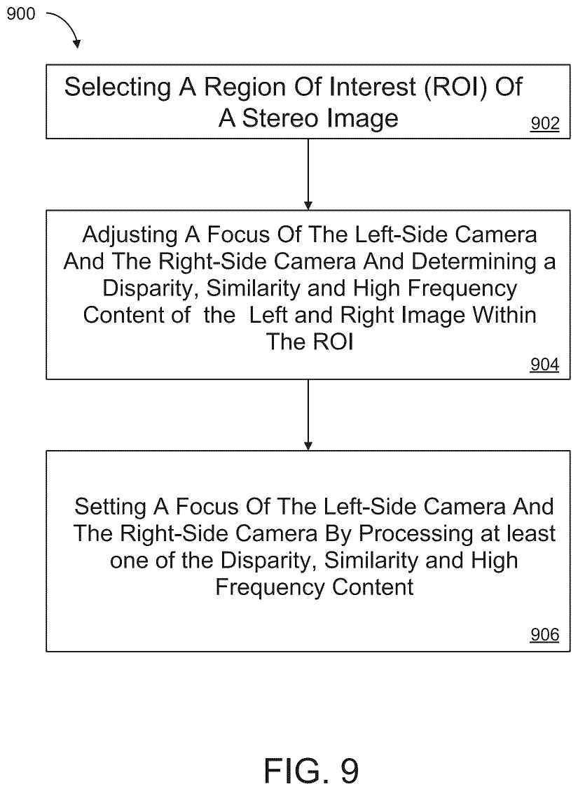

FIG. 9 provides a flowchart of an example arrangement of operations for a method 900 of focusing the stereoscopic imaging system 100. The stereoscopic imaging system 100 may be implemented in an exoscope 102 having a left-side camera 104 and a right-side camera 106. The left-side camera 104 and the right-side camera 106 generate a corresponding left-side image frame 114 and a right-side image frame 116 that define a stereo image 118. At step 902, the method 900 includes selecting a ROI 200 of the stereo image 118, which may be performed as described above. At step 904, the method 900 includes determining one of a disparity, similarity, and high frequency content between the left-side image frame 114 and the right side image frame 116 within the ROI 200. As described above, this focal adjustment may be performed by the CCU 112 actuating the motor 126 to advance or retract the focusing optics 132 and/or image sensors of the left-side camera 104 and the right-side camera 106 a predetermined distance so as to change the focus. At step 906, the method 800 includes setting the focus of the left-side camera 104 and the right-side camera 106 by processing the disparity, similarity and high frequency content between the left-side image frame 114 and the right-side image frame 116 within the ROI 200. In one aspect, the focus is set with the disparity, similarity and high-frequency content is within an acceptable value. For instance, the disparity between the left-side image frame 114 and the right-side image frame 116 is below the predetermined threshold; (2) a similarity in a pixel intensity between the between the left-side image frame 114 and the right-side image frame 116 is above a predetermined threshold; and (3) a high frequency content in the between the left-side image frame 114 and the right-side image frame 116 are above a predetermined threshold. Accordingly, a method 900 and a system 100 is described herein which may automatically set the focus of an ROI 200 of a three-dimensional image so as to improve the efficiency of the user and or a surgical procedure as the case may be.

In another aspect of the method 900, step 904 is performed iteratively in a closed-loop control using any one of the parameters discussed above. For instance, the focus of the left-side camera 104 and the right-side camera 106 is obtained by physically moving the left-side camera 104 and the right-side camera 106 towards or away from the object, and a disparity between the left-side image frame 114 and the right-side image frame 116 within the ROI 200 is calculated for each focus. This process continues until the smallest disparity is achieved. In such an aspect, step 906 may be modified to be selecting a focus having the smallest disparity of all the calculated disparities.

In another aspect, of the method 900, step 904 is performed by determining a disparity between the left-side image frame 114 and the right-side image frame 116 at the time the ROI is selected. The disparity may be determined by comparing the left-side image frame 114 and the right-side image frame 116 using known image processing techniques, such as pixel value comparison. The determined disparity may be processed to determine a depth of the ROI, or a target within the ROI. At the time the disparity is determined a baseline and the focal length is known. The baseline is a distance between the left-side camera 104 and the right-side camera 106. In the stereoscopic imaging system 100 described herein, the baseline remains a fixed value and the focal length is a property of the lens of the left-side camera 104 and the right-side camera 106 and are the same. The depth of the ROI may be calculated using the following equation: Z=f*b/d where “Z” is the depth, “f” is the focal length, “b” is the baseline and “d” is the calculated disparity.

The calculated depth may be used to set the focus of the imaging system 100, e.g. generate the focal plane 150 that corresponds to the calculated depth. This is done by moving the focusing optics 132 relative to the left and right image sensors 128, 130 (or vice versa), as illustratively shown in FIG. 2. It should be appreciated, that once the focus is set, step 904 may include determining the disparity between the left-side image frame 114 and the right-side image frame 116 at the time the focus is set and determining if the disparity is below a predetermined threshold or alternatively, the focus is adjusted until the smallest disparity is achieved.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. It should be particularly noted that the system 100 is described in the context of a motor 122 which changes the focus of the left-side camera 104 and the right-side camera 106 in stereo by changing the distance between a lens and image sensor; however, it should be appreciated that any method currently known or later developed for changing the focus may be adapted and used herein. Any such assembly is but a variation of the embodiments discussed above and does not depart from the sprit and scope of the disclosure. Accordingly, other implementations are within the scope of the following claims

What is claimed is:

1. A method for focusing a stereoscopic imaging system having a left-side image sensor and a right-side image sensor, the left-side image sensor and the right-side image sensor generating a corresponding left-side image and right-side image, the left-side image and the right-side image defining a stereo image, the method comprising:
providing an optical system including an adjustable focusing optics, the optical system configured to obtain a best focus focal plane for both the left side image and the right side image that corresponds to a zero, or near zero, disparity between the right side image and the left side image in the stereo image;
selecting a region of interest (ROI), the ROI being a region within one of the left-side image and the right-side image; and
setting a focus of the ROI by adjusting the adjustable focusing optics using, as a metric, one of a disparity, similarity and a high frequency content, wherein the focus of the ROI is set when at least one of the following conditions is satisfied: (1) the disparity between the left side image and the right side image is below a predetermined threshold; (2) the similarity in a pixel intensity between the left side image and the right side image is above a predetermined threshold; and (3) the high frequency content in the left side image and the right side image are above a predetermined threshold.

2. The method as set forth in claim 1, wherein the focus of the ROI is set by taking a weighted average of the disparity, similarity and high frequency information.

3. The method of claim 1, wherein the ROI is determined based on a user input at one of the left-side image and the right-side image.

4. The method of claim 1, wherein the ROI is determined based on a user input at the stereo image.

5. The method of claim 4, wherein, based on the user input at the stereo image, a graphic overlay representative of the ROI is displayed at both the left-side image and the right-side image.

6. The method of claim 1, wherein the disparity is determined by a distance between portions of the left-side image and the right-side image having the same or similar pixel values.

7. The method of claim 1, wherein the similarity is determined based on a difference in pixel values for corresponding portions of the left-side image and the right-side image.

8. The method of claim 1, wherein the similarity is determined based on at least one of a sum of squared differences and a sum of absolute differences of pixel intensity values of the right image relative to the left image within the ROI.

9. The method of claim 1, wherein the similarity is determined based at least in part on a correlation between the left-side image and the right-side image within the ROI.

10. The method of claim 9, wherein the correlation is determined based on at least one of (i) a normalized correlation, (ii) a cross correlation, (iii) a normalized cross correlation, and (iv) a zero normalized cross correlation.

11. A method for focusing a stereoscopic imaging system having a left-side image sensor and a right-side image sensor, the left-side image sensor and the right-side image sensor generating a corresponding left-side image and right-side image, the left-side image and the right-side image defining a stereo image, the method comprising:
providing an optical system including an adjustable focusing optics, the optical system configured to obtain a best focus focal plane for both the left side image and the right side image that corresponds to a zero, or near zero, disparity between the right side image and the left side image in the stereo image;
selecting a region of interest (ROI), the ROI being a region within one of the left side image and the right side image; and
determining a disparity between the left side image and the right side image at the ROI;
processing the disparity to determine a depth of the region of interest;
processing the depth to set a focus of the adjustable optics.

12. The method of claim 11, further including adjusting the focus until the disparity between the left side image and the right side image is below a predetermined threshold.

13. The method of claim 12, wherein the disparity is determined by a horizontal pixel distance between corresponding regions of the left-side image and the right-side image.

14. The method of claim 11, wherein the disparity is determined based at least in part on a correlation between the left-side image and the right-side image within the ROI.

15. The method of claim 14, wherein the correlation is determined based on at least one of (i) a normalized correlation, (ii) a cross correlation, (iii) a normalized cross correlation, and (iv) a zero normalized cross correlation.

16. A stereoscopic imaging system comprising:
a left-side camera that captures left-side images;
a right-side camera that captures right-side images;
an optical system including adjustable focusing optics, the optical system configured obtain a best focus focal plane for both the left side image and the right side image that corresponds to a zero, or near zero, disparity between the right side image and the left side image in the stereo image;
an input for selecting a region of interest (ROI), the ROI being a region within one of the left side image and the right side image and the stereo image;
a controller that receives captured left-side images from the left-side camera and captured right-side images from the right-side camera, the left-side image and the right-side image defining a stereo image, and the controller including memory hardware and data processing hardware in communication with the memory hardware, the memory hardware storing instructions that, when executed on the data processing hardware, cause the data processing hardware to perform operations including:
adjusting a focus of the left-side camera and the right-side camera comparing the left-side image and the right-side image within a Region of Interest (ROI) of the stereo image; and
setting the focus of the left-side camera and the right-side camera by processing a disparity, similarity and high frequency content of the left-side image and the right-side image, wherein the focus of the ROI is set when at least one of the following conditions is satisfied: (1) a disparity between the left side image and the right side image is below a predetermined threshold; (2) a similarity in a pixel intensity between the left side image and the right side image is above a predetermined threshold; and (3) a high frequency content in the left side image and the right side image are above a predetermined threshold.

17. The stereoscopic imaging system of claim 16, the controller is further configured to set the focus of the ROI by taking a weighted average of the disparity, similarity and high frequency information.

18. The stereoscopic imaging system of claim 16, wherein the disparity is determined based on at least one of a sum of squared differences and a sum of absolute differences.

19. The stereoscopic imaging system of claim 16, wherein the similarity is determined based at least in part on a correlation between the left-side image and the right-side image within the ROI.

20. The stereoscopic imaging system of claim 19, wherein the correlation is determined based on at least one of (i) a normalized correlation, (ii) a cross correlation, (iii) a normalized cross correlation, and (iv) a zero normalized cross correlation.
